(19) United States
(12) Patent Application Publication
(10) Pub. No.: US 2010/0067143 A1
(43) Pub. Date: Mar. 18, 2010

(54) MAGNETIC DISK APPARATUS

(75) Inventor: Goroh Kawasaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/499,492

(22) Filed: Jul. 8, 2009

(30) Foreign Application Priority Data
Sep. 16, 2008 (JP) 2008-236391

(51) Int. Cl. G11B 33/14

(52) U.S. Cl. 360/97.02; G9B/33.035

(57) ABSTRACT

A magnetic disk apparatus includes a housing, a rotatable magnetic disk arranged in the housing, a nitrogen separation film module for separating nitrogen from air outside the housing, a nitrogen introduction path for guiding nitrogen from the nitrogen separation film module into the housing, and a negative pressure generator for generating negative pressure by utilizing static pressure drop at the obverse surface of the magnetic disk in rotation. The negative pressure generator is attached to an end of the nitrogen introduction path in the housing.

### CROSS-REFERENCE TO RELATED APPLICATION

This application is based upon and claims the benefit of priority of the prior Japanese Patent Application No. 2008-236391, filed on Sep. 16, 2008, the entire contents of which are incorporated herein by reference.

### FIELD

An embodiment of the present invention relates to a magnetic disk apparatus.

### BACKGROUND

A conventional method for prolonging the life of a magnetic disk apparatus is to fill the housing of the disk apparatus with an inert gas such as nitrogen gas. In this manner, the internal parts of the magnetic disk apparatus are not exposed to the air, in particular to the oxygen, thereby prevented from deteriorating.

An example of magnetic disk apparatus with an inert gas sealed in the housing is disclosed in Japanese Laid-open Patent Publication No. 52-038908. With the arrangement of this apparatus, however, the housing may be deformed when the external pressure varies, whereby proper reading and writing operation may not be performed.

Japanese Laid-open Patent Publication No. 59-132459 teaches a tank of nitrogen gas from which nitrogen gas is supplied into the housing of a magnetic disk apparatus so that the internal pressure remains to be slightly higher than the atmospheric pressure. With this arrangement, however, the deformation of the housing can still occur when the external pressure varies significantly. Further, when the nitrogen in the tank is used up, the deterioration of the internal parts will be inevitable. Furthermore, the additional nitrogen gas tank is essential, which makes it difficult to produce a compact magnetic disk apparatus to be incorporated in a portable device.

### SUMMARY

According to an aspect of the invention, a magnetic disk apparatus includes a housing, a rotatable magnetic disk arranged in the housing, a nitrogen separation film module for separating nitrogen from air outside the housing, a nitrogen introduction path for guiding nitrogen from the nitrogen separation film module into the housing, and a negative pressure generator for generating negative pressure by utilizing static pressure drop at the obverse surface of the magnetic disk in rotation. The negative pressure generator is attached to an end of the nitrogen introduction path in the housing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a perspective view illustrating a magnetic disk apparatus according to an embodiment of the present invention;

FIG. 2 is a sectional view illustrating a principal portion of the magnetic disk apparatus of FIG. 1;

FIG. 3 is a perspective view illustrating a principal portion of the magnetic disk apparatus of FIG. 1;

FIG. 4 illustrates the relationship between the depth of the cylindrical hollow of the surface of a negative pressure generator and the negative pressure generated;

FIG. 5 illustrates the relationship between the distance between the negative pressure generator and the magnetic disk and the negative pressure generated;

FIG. 6 illustrates the relationship between the height and the negative pressure generated; and

FIG. 7 is a sectional view illustrating a principal portion of a magnetic disk apparatus according to another embodiment of the present invention.

### DESCRIPTION OF EMBODIMENTS

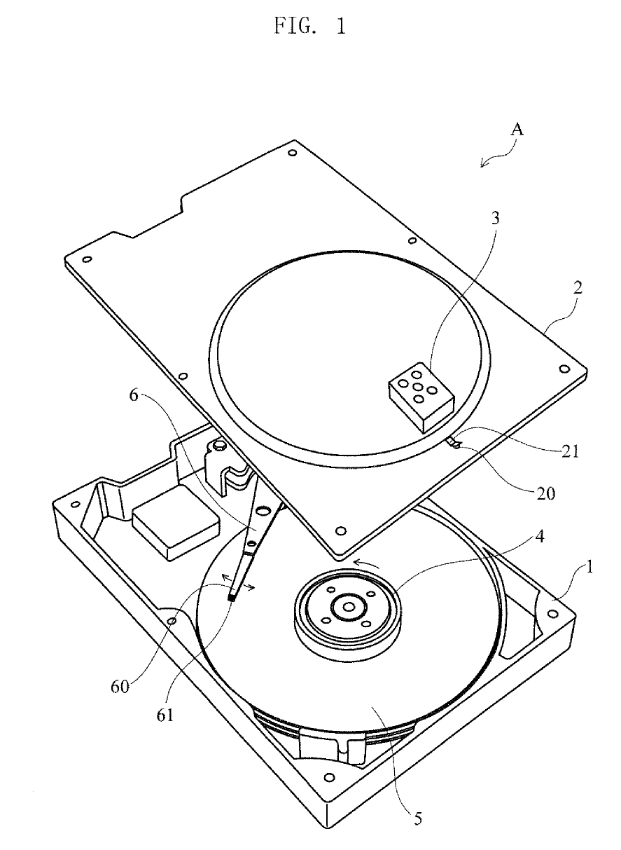

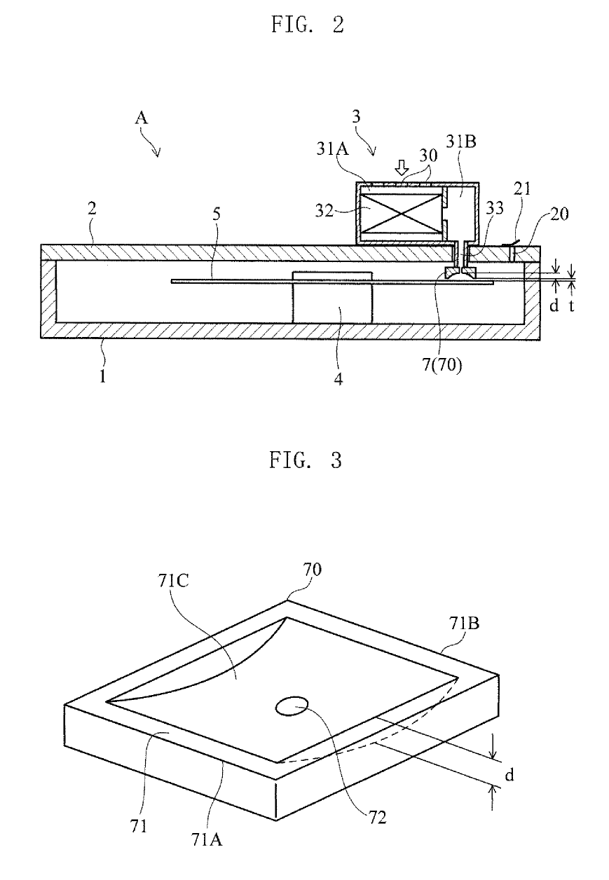

FIGS. 1-3 illustrate a magnetic disk apparatus according to an embodiment of the present invention. The magnetic disk apparatus A of this embodiment includes a housing body 1, a housing cover 2, a nitrogen separation film module 3, a spindle motor 4, a magnetic disk 5, a swing arm 6 and a negative pressure generator 7.

The housing body 1 and the housing cover 2 are made of a metal and constitute a housing for accommodating the parts such as the spindle motor 4 and the magnetic disk 5. The nitrogen separation film module 3 is fixed to the outer surface of the housing cover 2. The housing cover 2 is formed with a relatively small exhaust port 20 for providing communication between the inside and the outside of the housing. The exhaust port 20 is provided with a check valve 21. When the pressure in the housing exceeds the external pressure, the check valve 21 allows gas to be discharged from the housing, but prevents gas from flowing into the housing.

The nitrogen separation film module 3 includes a case 31 formed with air inlets 30, a nitrogen separation film 32 arranged in the case 31 and a nitrogen introduction path 33 for guiding nitrogen to the negative pressure generator 7.

In the case 31, a nitrogen separation chamber 31A and a negative pressure generation chamber 31B are defined to communicate with each other. The nitrogen separation film 32 is arranged in the nitrogen separation chamber 31A so that air introduced through the air inlets 30 comes into contact with the nitrogen separation film 32. The negative pressure generation chamber 31B is connected to the negative pressure generator 7 via the nitrogen introduction path 33. Thus, the negative pressure generated in the negative pressure generator 7 acts on the negative pressure generation chamber 31B.

The nitrogen separation film 32 is e.g. an inorganic porous zeolite film. Nitrogen contained in the air on the high-pressure side passes through the nitrogen separation film 32 to the low-pressure side at a higher speed than the speed at which oxygen contained in the air on the high-pressure side passes through the nitrogen separation film 32 to the low-pressure side. Conceivably, this is because the nitrogen separation film 32 includes minute pores which do not allow relatively large oxygen molecules to pass but allows relatively small nitrogen molecules to pass. When negative pressure is applied to the nitrogen separation film 32, external air is attracted to the nitrogen separation film 32. The nitrogen separation film 32 allows nitrogen in the air to pass therethrough more than oxygen in the air. The nitrogen passing through the nitrogen separation film 32 is guided from the negative pressure generation chamber 31B to the negative pressure generator 7 through the nitrogen introduction path 33.

The nitrogen introduction path 33 is defined by e.g. a metal pipe. The nitrogen introduction path 33 extends through the housing cover 2 into the housing. The negative pressure generator 7 is connected to an end of the nitrogen introduction path 33.

The spindle motor 4 rotates the magnetic disk 5 at a speed of e.g. 6000 rpm.

The magnetic disk 5 is a medium for reading or writing magnetic information. The reading or writing of magnetic information is performed using a magnetic head attached to an end of the swing arm 6.

In reading or writing magnetic information, the swing arm 6 is pivoted by a voice coil motor to a desired position in the radial direction of the magnetic disk 5. The swing arm 6 holds a slider 61 connected to an end of the swing arm via a suspension 60. The slider 61 is provided with a magnetic head.

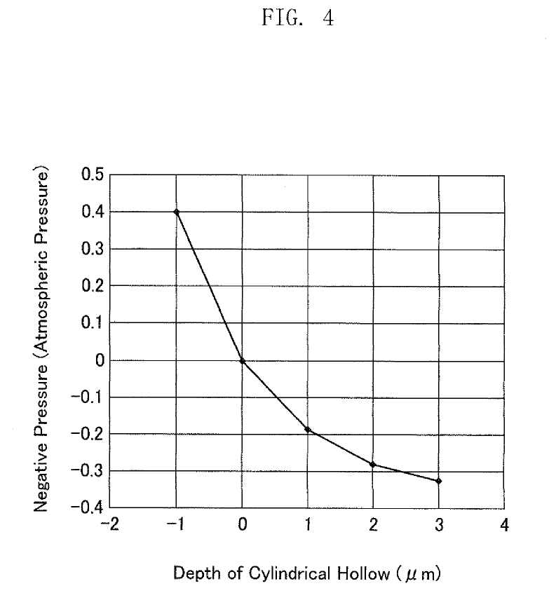

The negative pressure generator 7 is arranged adjacent to the obverse surface of the magnetic disk 5. The negative pressure generator 7 includes a disk-facing member 70 illustrated in FIG. 3.

The disk-facing member 70 has a size of e.g. about 3 mm×3 mm and includes a disk-facing surface 71 which faces the obverse surface of the magnetic disk 5 at a predetermined distance t. The distance t may be about 3 μm. The disk-facing surface 71 is formed with a nitrogen introduction hole 72 communicating with the nitrogen introduction path 33. The disk-facing surface 71 is part of a cylindrical surface (or an oval cylindrical surface) extending in the radial direction of the magnetic disk 5 and hollowed from the two end portions or edges 71A and 71B (which are spaced from each other in the rotation direction of the magnetic disk 5) toward a center portion 71C. Thus, the disk-facing surface 71 includes a height difference d between the center portion 71C, which is the deepest portion, and the two edges 71A, 71B. The height difference d corresponds to the depth of the cylindrical hollow of the surface and may be about 3 pm. The nitrogen introduction hole 72 is formed at the center portion 71C. By arranging the disk-facing surface 71 of the disk-facing member 70 to face the obverse surface of the magnetic disk 5 at a distance t, negative pressure is generated when the static pressure at the obverse surface of the magnetic disk 5 drops. The negative pressure acts on the negative pressure generation chamber 31B via the nitrogen introduction path 33.

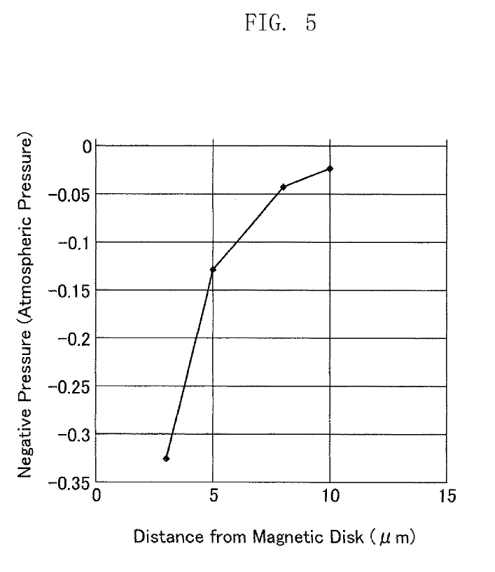

The operation and advantages of the magnetic disk apparatus A will be described below with reference to FIGS. 4-6.

In reading or writing magnetic information, the magnetic disk 5 is rotated at high speed in the magnetic disk apparatus A. Since the disk-facing surface 71 of the disk-facing member 70 is positioned adjacent to the obverse surface of the magnetic disk 5, the static pressure on the disk-facing surface 71 drops due to the air flow generated between the magnetic disk 5 and the disk-facing surface 71, and hence, negative pressure is generated.

The negative pressure generated at the disk-facing member 70 acts on the negative pressure generation chamber 31B via the nitrogen introduction hole 72 and the nitrogen introduction path 33. Thus, the negative pressure acts on the inside of the nitrogen separation film 32 via the negative pressure generation chamber 31B. As a result, a pressure difference is generated between the outer portion of the nitrogen separation film 32, which comes into contact with air from the air inlets 30, and the inner portion of the nitrogen separation film 32, so that air is attracted to the nitrogen separation film 32.

Nitrogen contained in the air attracted to the nitrogen separation film 32 passes through the nitrogen separation film 32 and is introduced into the negative pressure generation chamber 31B more efficiently than oxygen contained in the air. The nitrogen introduced into the negative pressure generation chamber 31B is guided to the nitrogen introduction hole 72 through the nitrogen introduction path 33 and diffuses in the housing of the magnetic disk apparatus A. Thus, the interior of the housing of the magnetic disk apparatus A is filled with nitrogen gas.

The loading of nitrogen gas into the housing continues as long as the magnetic disk 5 rotates. When the pressure in the housing exceeds the pressure outside the housing, the check valve 21 opens so that excess nitrogen gas is discharged from the housing through the exhaust port 20. Thus, the housing body 1 and the housing cover 2 are prevented from being deformed due to the pressure difference between the inside and the outside of the housing.

From the simulation results illustrated in FIG. 4, it is found that a lager negative pressure is generated as the depth d of the cylindrical hollow of the disk-facing surface 71 increases. The depth d of about 3 μm employed in this embodiment provides a negative pressure which is sufficiently lower than the atmospheric pressure outside the housing.

From the simulation results illustrated in FIG. 5, it is found that a lager negative pressure is generated as the distance t between the magnetic disk 5 and the disk-facing surface 71 reduces. The distance t of about 3 μm employed in this embodiment provides a negative pressure which is sufficiently lower than the atmospheric pressure outside the housing.

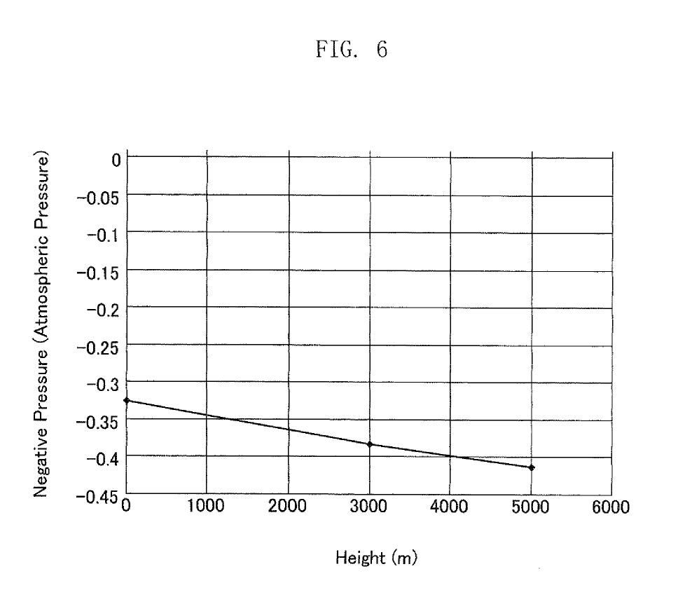

The simulation results illustrated in FIG. 6 indicates that the disk-facing member 70 of this embodiment reliably generates a negative pressure which is sufficiently lower than the atmospheric pressure outside the housing even when the atmospheric pressure changes due to the height change. Thus, even when portable equipment incorporating the magnetic disk apparatus A is used in a low pressure environment, a negative pressure which is sufficient to fill the housing with nitrogen is reliably generated.

In the magnetic disk apparatus A of this embodiment, static pressure drop at the surface of the rotating magnetic disk 5 is utilized to generate a negative pressure at the disk-facing member 70. The negative pressure is applied to the portion connecting the nitrogen introduction path 33 and the nitrogen separation film 32 so that the outside air is attracted to the nitrogen separation film 32. Thus, as long as the magnetic disk 5 rotates, the housing is filled with nitrogen gas separated from the air by the nitrogen separation film 32.

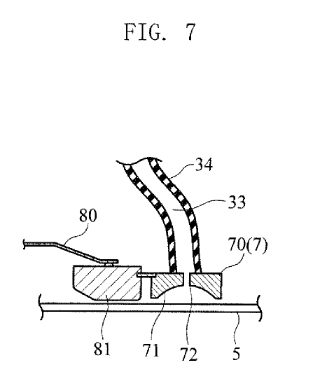

FIG. 7 illustrates another embodiment of the magnetic disk apparatus according to the present invention. The magnetic disk apparatus of this embodiment includes a nitrogen separation film module and a disk-facing member 70 as a negative pressure generator. The magnetic disk apparatus of this embodiment differs from that of the foregoing embodiment in the points described below.

The magnetic disk apparatus includes an arm (not illustrated) which holds a slider 81 connected to an end of the arm via a suspension 80. The slider 81 supports the disk-facing member 70. It is to be noted that the slider 81 is a part for exclusively holding the disk-facing member 70 and different from the slider 61 to which a magnetic head as a reading/writing head is attached. The nitrogen introduction path 33 is defined by a flexible tube 34, and an end of the tube 34 is connected to the nitrogen separation film module. Another end of the tube 34 is arranged in the housing to be connected to the nitrogen introduction hole 72 of the disk-facing member 70. In reading or writing magnetic information, the disk-facing member 70 is moved along with the slider 81 to come close to the obverse surface of the magnetic disk 5.

With this arrangement, when the magnetic disk 5 rotates at high speed, the distance between the magnetic disk 5 and the slider 81 is kept constant by the air bearing effect. As a result, the distance between the obverse surface of the magnetic disk 5 and the disk-facing member 70 is also kept substantially constant. Thus, as long as the magnetic disk 5 rotates, negative pressure of a sufficient level is efficiently generated.

The present invention is not limited to the foregoing embodiments. The structures of the foregoing embodiments are merely examples and may be appropriately varied in design in accordance with the specifications. For instance, the nitrogen separation film module and the exhaust port may be provided at the housing body.

What is claimed is:

1. A magnetic disk apparatus comprising:
a housing;
a rotatable magnetic disk arranged in the housing;
a nitrogen separation film module for separating nitrogen from air outside the housing;
a nitrogen introduction path for guiding nitrogen from the nitrogen separation film module into the housing; and
a negative pressure generator for generating negative pressure by utilizing static pressure drop at an obverse surface of the magnetic disk in rotation, the negative pressure generator being attached to an end of the nitrogen introduction path in the housing.

2. The magnetic disk apparatus according to claim 1, wherein the negative pressure generator comprises a disk-facing member including: a disk-facing surface that faces the obverse surface of the magnetic disk at a distance; and a nitrogen introduction hole connected to the end of the nitrogen introduction path.

3. The magnetic disk apparatus according to claim 2, wherein the disk-facing surface includes two end portions spaced from each other in a rotation direction of the magnetic disk, and a center portion between the two end portions, the disk-facing surface is hollowed from the two end portions toward the center portion, and the nitrogen introduction hole has an opening at the center portion.

4. The magnetic disk apparatus according to claim 3, wherein the disk-facing surface forms part of a cylindrical surface or an oval cylindrical surface extending in a radial direction of the magnetic disk.

5. The magnetic disk apparatus according to claim 1, wherein the housing is formed with an exhaust port provided with a check valve for allowing gas to be discharged from the housing and preventing gas from flowing into the housing.

6. The magnetic disk apparatus according to claim 2, further comprising a slider that floats above the magnetic disk and supports the disk-facing member, wherein at least part of the nitrogen introduction path is defined by a flexible tube.
